(19) United States
(12) Patent Application Publication
(10) Pub. No.: US 2025/0307807 A1
(43) Pub. Date: Oct. 2, 2025

(54) SYSTEM AND METHOD FOR COLLABORATIVE CONSENSUS PROTOCOLS

(71) Applicant: Synota Inc., Worthington, OH (US)

(72) Inventors: Maxwell DIGNAN, Delaware, OH (US); Austin MITCHELL, Worthington, OH (US)

(21) Appl. No.: 19/094,559

(22) Filed: Mar. 28, 2025

Related U.S. Application Data
(60) Provisional application No. 63/572,044, filed on Mar. 29, 2024.

(51) Int. Cl. G06Q 20/38; G06Q 20/40; H04L 9/08; H04L 9/32

(52) U.S. Cl. CPC G06Q 20/3829; G06Q 20/3825; G06Q 20/401; H04L 9/0825; H04L 9/3252

(57) ABSTRACT

A protocol for collaborative consensus that allows for the automatic cross-verification of outputs for a given contract between two parties. This allows for the autonomous reconciliation of bills throughout a billing period, and the automatic exchange of payments for the agreed-upon amounts. This is achieved using independent servers that have agreed upon a contract and its inputs and operations. The contract is serialized and signed by both parties, and then the outputs are cross verified by both parties. If the outputs are within an appropriate tolerance window, then the outputs are agreed upon and the payments are exchanged. If the outputs are not within an appropriate tolerance window, then the outputs are recalculated and exchanged again. This allows for the reduction of manual effort in the billing and payment process, and the reduction of moral hazard in the interaction of partially trusting counterparties.

### CROSS-REFERENCE TO RELATED APPLICATIONS

This application claims priority to U.S. provisional patent application Ser. No. 63/572,044, filed on Mar. 29, 2024. Priority to the provisional patent application is expressly claimed, and the disclosure of the provisional application is hereby incorporated herein by reference in its entirety and for all purposes.

### FIELD

This present disclosure relates generally to digital protocols, and more specifically, but not exclusively, to a collaborative consensus protocol for automating contract settlement and enforcement between counterparties through automated, verifiable agreements via direct peer-to-peer communication and cryptographic verification of inputs, operations, and outputs.

### BACKGROUND

In today's increasingly interconnected and complex business landscape, establishing trust, transparency, and efficiency in contractual settlement and enforcement between counterparties is paramount. Traditional manual processes for contract settlements, involving the exchange and reconciliation of inputs, calculations, and outputs, are plagued by inefficiencies, risk, and the potential for disputes and enforcement actions. These challenges are particularly prevalent in industries involving frequent settlement, dynamic data sources, and/or complex settlement terms.

To address these issues, various approaches have been proposed, including blockchain-based smart contracts and decentralized applications (DApps). While these solutions offer trustless execution and immutable record-keeping, they often suffer from scalability limitations and high costs associated with achieving global consensus across a decentralized network.

The manual reconciliation of contracts between counterparties is a time-consuming, error-prone process that often leads to disputes, delays, and inefficiencies. In industries like energy, where contracts involve complex calculations based on dynamic data sources, the challenges of manual reconciliation are particularly acute. Counterparties must exchange inputs, perform calculations, and verify outputs to ensure that both parties have an identical understanding of the agreed-upon terms. Beyond energy and payments, these same complications exist for all commodities, and in regulatory compliance and quality assurance, healthcare, insurance, lending, logistics, and other industries where a system of automated verification, serialization, and peer-to-peer agreement are valuable.

Existing solutions to automate contract settlement and/or enforcement, such as blockchain-based smart contracts, offer trustless execution and immutable record-keeping. However, these solutions require costly global consensus mechanisms to achieve agreement across a decentralized network. The usage of global consensus mechanisms is costly because all members of the global consensus—not just the members of the contract—must receive the data and run calculations upon it, for each settlement step in the process. As a result, the scalability and cost challenges associated with blockchain networks, whether public or private, limit their applicability in real-world scenarios where automated settlements and enforcement are valuable.

In view of the foregoing, a need exists for an improved system and method for automating contract settlement and enforcement between counterparties to overcome the aforementioned obstacles and deficiencies of conventional manual reconciliation, verification, and generic smart contract technology.

### BRIEF DESCRIPTION OF THE SEVERAL VIEWS OF THE DRAWINGS

FIG. 1 is an exemplary top-level diagram illustrating one embodiment of a system environment of the collaborative consensus protocol.

FIG. 2A is an exemplary top-level diagram illustrating another embodiment of the system environment of the collaborative consensus protocol of FIG. 1.

FIG. 2B is an exemplary top-level diagram illustrating one embodiment of the consumer device and supplier device of the system environment of the collaborative consensus protocol of FIG. 1.

FIG. 3 is an exemplary top-level diagram illustrating one embodiment of a process for contract serialization using the collaborative consensus protocol of FIG. 1.

FIG. 4 is an exemplary top-level diagram illustrating one embodiment of a process for contract deserialization using the collaborative consensus protocol of FIG. 1.

FIG. 5 is an exemplary top-level diagram illustrating one embodiment of a process for signing a raw serialized contract against the private key using the collaborative consensus protocol of FIG. 1.

FIG. 6 is an exemplary top-level diagram illustrating one embodiment of a process for signature verification using the collaborative consensus protocol of FIG. 1.

FIG. 7 is an exemplary top-level diagram illustrating one embodiment of a process for agreement, exchange, and verification using the collaborative consensus protocol of FIG. 1.

FIG. 8 is an exemplary top-level diagram illustrating one embodiment of a data flow diagram for invoicing of the collaborative consensus protocol of FIG. 1.

FIG. 9 is an exemplary top-level diagram illustrating one embodiment of a data flow diagram for generating payment requests using the collaborative consensus protocol of FIG. 1.

FIG. 10 is an exemplary top-level diagram illustrating one embodiment of a data flow diagram for preparing audit reports of the collaborative consensus protocol of FIG. 1

FIG. 11 is an exemplary top-level diagram illustrating one embodiment of a state diagram for processing payments of FIG. 8.

FIG. 12 is an exemplary top-level diagram illustrating one embodiment of a data flow diagram for processing partial payments of the collaborative consensus protocol of FIG. 1.

FIG. 13 is an exemplary top-level diagram illustrating one embodiment of a data flow diagram for processing payments through banks of the collaborative consensus protocol of FIG. 1.

FIGS. 14A-I are each exemplary screenshots showing various user interfaces for the collaborative consensus protocol of FIG. 1.

FIGS. 15A-B are each exemplary top-level diagrams illustrating alternative embodiments of the system environment of the collaborative consensus protocol of FIG. 1.

It should be noted that the figures are not drawn to scale, and that elements of similar structures or functions are generally represented by like reference numerals for illustrative purposes throughout the figures. It also should be noted that the figures are only intended to facilitate the description of the preferred embodiments. The figures do not illustrate every aspect of the embodiments described and do not limit the scope of the present disclosure.

### DETAILED DESCRIPTION

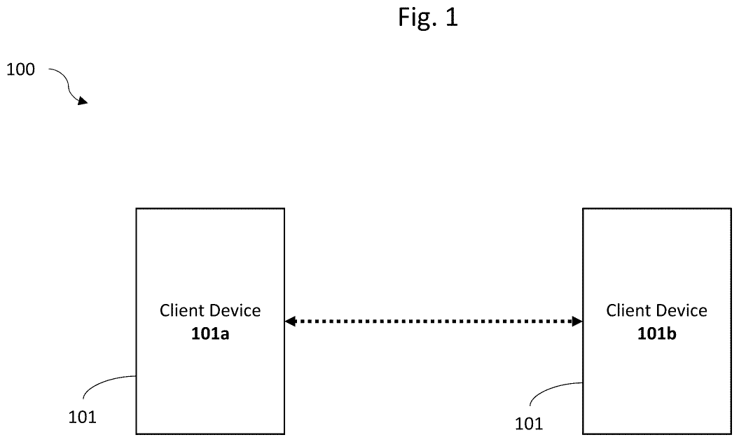

Currently available contract enforcement systems are difficult to scale and have limited real-time settlement functionality. A collaborative consensus protocol enables automated, verifiable agreement between counterparties without the need for a blockchain or global consensus. Using a collaborative consensus protocol system 100 shown in FIGS. 1-7, achieves this result. Leveraging peer-to-peer communication, cryptographic signatures, and iterative verification processes, the collaborative consensus protocol streamlines contract enforcement while maintaining a high degree of trust, transparency, and efficiency, without divulging sensitive information to a central authority.

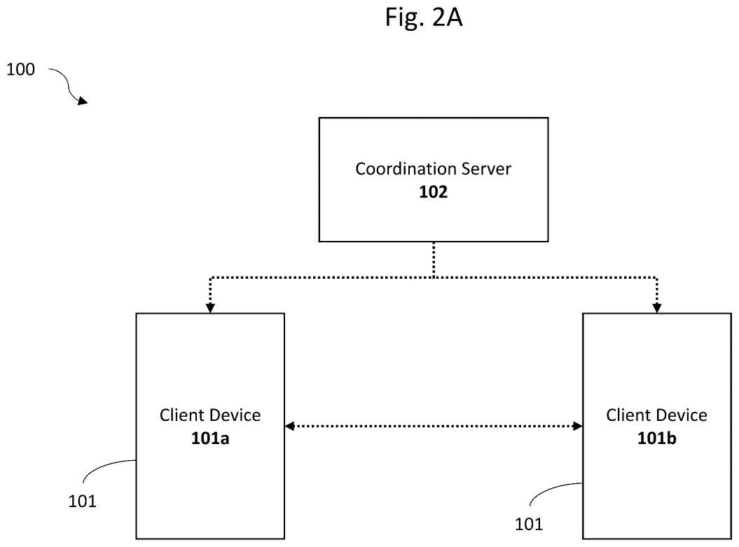

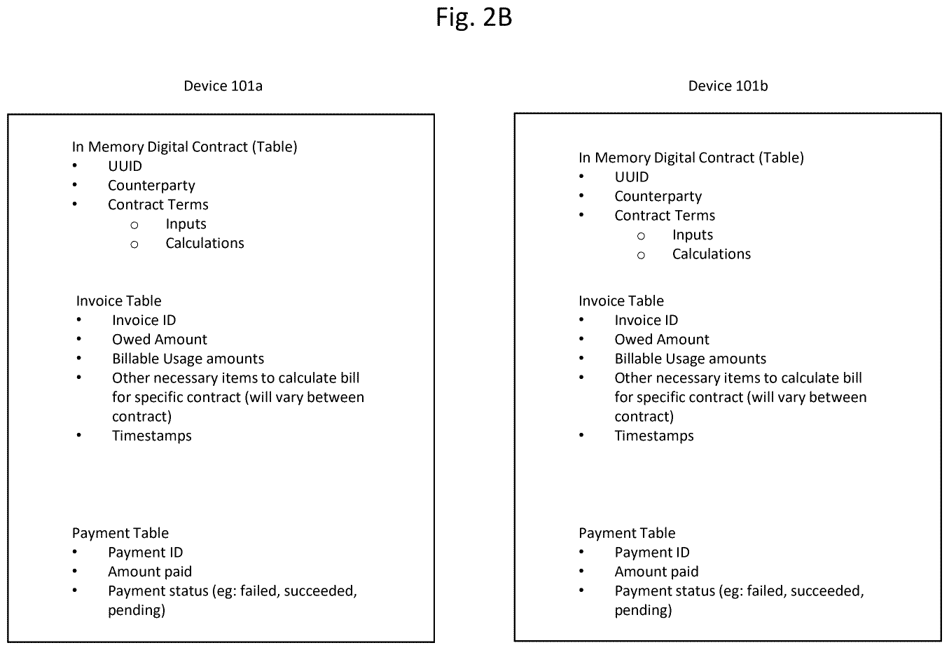

The disclosed system 100 comprises at least two client devices 101, such as a first client device 101a and a second client device 101b as shown in FIG. 1. The client devices 101 can communicate bidirectionally with each other without a centralized server. In some embodiments, with reference to FIG. 2A, a coordination server 102 can assist the client devices 101 with the initial connection by aiding each counterparty in being able to have the necessary information to be able to find and communicate, across the Internet (or other medium), appropriately.

By using client devices 101a and 101b owned by each counterparty and not a separate, central entity, each counterparty's sensitive data related to the contract, such as the rate of expense per unit of energy or the amount of energy consumed, is maintained in a secure and private manner without exposure to entities outside of the contractual agreement. Although shown and described as counterparties to a contract in exemplary embodiments, the client devices 101a and 101b can represent multiple parties to a contract as desired (e.g., clients, suppliers, consumers, and so on).

In some embodiments, contract settlement serves to verify and reconcile financial data; however, the disclosed systems and methods can be applied to any dataset that requires cross-verification, such as ensuring identical datasets exist among counterparties, or comparing similar or related datasets from various sources to measure accuracy, monitor compliance or determine completeness. Contract execution and verification extends to payments and many data-driven agreements, where any deviations in inputs and outputs affect contract enforcement.

### P2P, Peer-Discovery, and Coordination Server 102

In some embodiments, the collaborative consensus protocol leverages direct peer-to-peer communication between counterparties to establish automated, verifiable agreement on contractual terms, inputs, operations, and outputs. The benefit of leveraging peer-to-peer communication-especially over encrypted channels (e.g., Hypertext Transfer Protocol Secure (HTTPS))—allows for the information exchanged between the parties to be kept private from competitors or other parties that, from the perspectives of the contracted parties, should not be able to view the information of or related to the contract. To facilitate this communication, counterparties know each other's node identifier (e.g., email address or other unique identifier) and public keys (pubkeys) ahead of time. In some embodiments, this information, along with the location of the coordination server 102, is exchanged out-of-band (e.g., via outside communication methods such as email or phone). To establish connection, counterparties agree to use the coordination server 102, which server 102 maintains a mapping (e.g., such as a hash map) of node identifiers (e.g., email and/or public keys) to the up-to-date domain name records for counterparties. This simplifies the process of finding and connecting with their counterparty's valid server.

FIG. 2A illustrates an exemplary data flow of the coordination server 102 initializing communication between a first client device 101 (a consumer device 101a) and a second client device 101 (a supplier device 101b). In some embodiments, connection data for other clients is cached locally for a predefined duration (e.g., 60 seconds) to allow for dynamic updates to DNS configurations without requiring manual reconfiguration. Upon expiration of the cache, the client device queries the coordination server for the latest connection information, ensuring continued connectivity with minimal administrative overhead. In alternative embodiments, the system operates without a coordination server, relying instead on statically configured connection parameters defined manually on each client device.

In a preferred embodiment, each client device 101 acts as both a supplier and a consumer, enabling cascading, multiparty contractual relationships. For example, a single party operating the first client device 101 (user A of the client device 101a) may be receiving services or goods from another party operating the second client device 101b (user b of the client device 101b). Simultaneously, user B may also act as a consumer in a separate agreement with a user C, operating a separate client device 101c (not shown). This structure allows for a serial chain of contracts, in which obligations flow downstream, and payments or verifications flow upstream.

This configuration supports multiparty collaborative consensus, whereby a single contractual input or data point (e.g., metered usage or delivered quantity) can trigger a series of independently verified, yet interconnected, settlements across multiple parties. Each link in the contractual chain independently performs validation, signature verification, and output reconciliation, ensuring data integrity and consistency without requiring global consensus. This model facilitates dynamic, trust-minimized coordination across multiple stakeholders, such as in supply chains, energy markets, or financial consortia, where parties may be both consumers and suppliers at different layers of a value chain.

In some examples, the consumer device 101a provides the coordination server 102 with the counterparty's node identifier (e.g., the email and pubkey of the user of the supplier device 101b) to request the domain information of the supplier device 101b. The coordination server 102 provides the appropriate domain information to enable the supplier device 101b to provide information and communicate directly to the consumer device 101a.

Exemplary data structures maintained by each client device 101 are shown in FIG. 2B. With reference to FIG. 2B, the data stored in these data structures (e.g., tables) can be identified by a universally unique identifier (UUID) of the contract, which UUID matches between counterparties to ensure an auditable transaction record.

In alternative embodiments, a decentralized peer-discovery mechanism is implemented to further enhance the protocol's robustness and accessibility. This mechanism allows for the mapping of the node identifiers and pubkeys to their related domain name records without the out-of-band exchange of said node identifiers emails and pubkeys discussed above. For example, in some embodiments, instead of a coordination server 102, the mapping of node identifiers and pubkeys to their related domain name records can be implemented using magnet servers, bitcoin transactions to store information in a distributed way, gossip protocols, etc.

### Contract Serialization

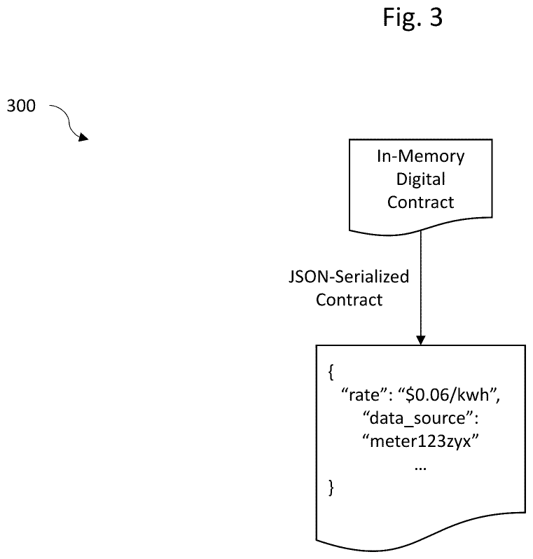

With reference to FIG. 3, in a preferred embodiment, contracts are written in a serialized format, such as using a special JavaScript Object Notation (JSON) schema that captures the terms (e.g., the rate of dollars owed per unit of consumption, pass through charges, tax rates, demand charges, site capacity, etc.), inputs (e.g., amount of energy consumed, interest rates, dynamic prices, etc.), operations (e.g., mathematical formulas by which the terms and inputs evaluate to a final output, including summation and multiplication, but also estimating and filtering data based on thresholds), and outputs (e.g., invoice amount, calculation subtotals, payment amount, informational reports, etc.) of the agreement. Contracts written in a serialized format enable the contract information to be transferred between client devices and/or compared for equality—or specific differences—even in the case that client devices are using different implementations.

As shown in FIG. 3, the digital contract is loaded on the client device 101, in a state where it can be used by the application. In one embodiment, the digital contract is serialized to share information between the parties. Counterparty identifier, such as email, is part of the digital contract. In this embodiment, serialization occurs only when the digital contract needs to be sent/shared and signed, thus keeping the digital contract in a serialized state for the minimum time possible and reducing the potential the digital contract become out of date with what is stored.

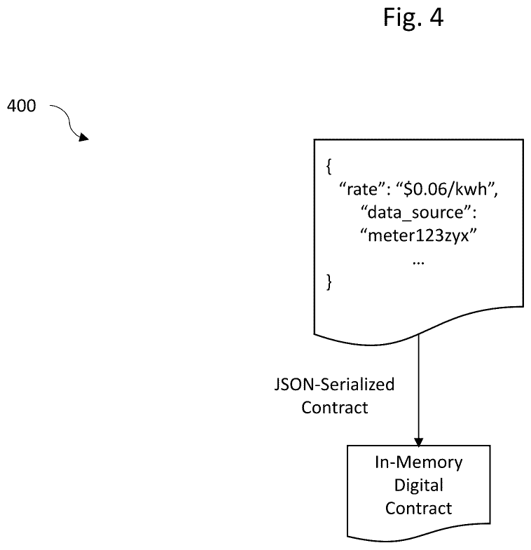

Turning to FIG. 4, each counterparty imports the serialized contract into their machine (their client device 101), where it is deserialized into a machine-understandable representation for comprehension by the contract-execution code on the client device. The deserialization of the digital contract advantageously enables the client device 101 to understand what values and information is present in the serialized form of the digital contract. The digital contract is deserialized to be accepted and readable by the counterparty. Serialization and deserialization ensure counterparties have identical copies of the digital contract at the time of signing. In some embodiments, JSON is used for serialization. However, one of ordinary skill in the art can appreciate that alternative methods of serialization and deserialization can be used, such as Protocol Buffers. These operations can be executed by software modules, including but not limited to autonomous AI agents, which process inputs to generate outputs based on the contract's terms.

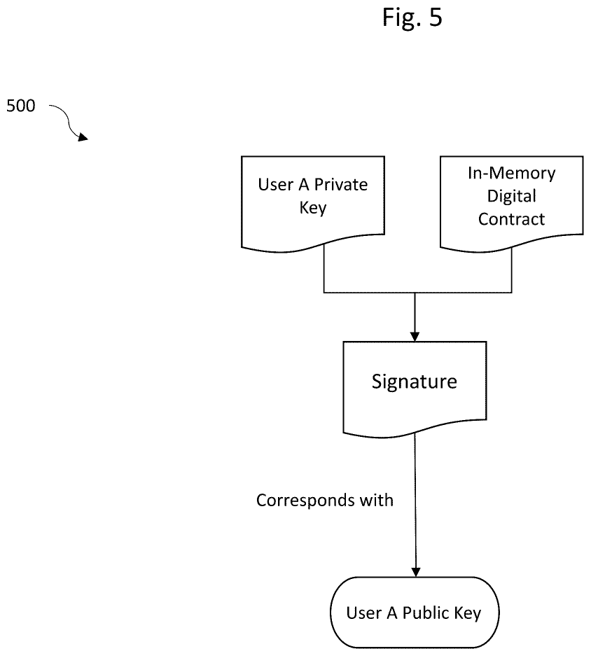

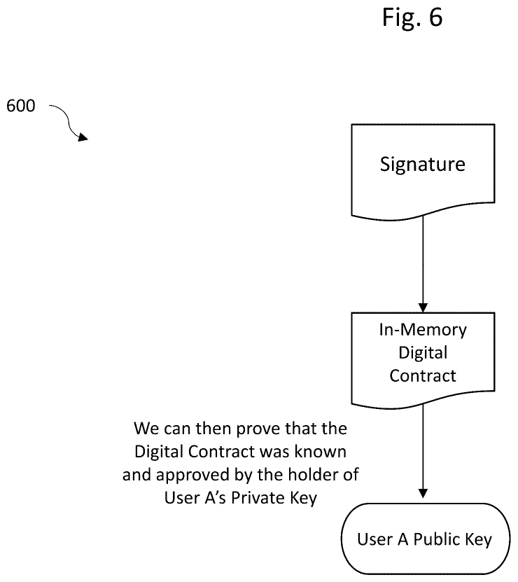

As shown in FIG. 5, the raw serialized contract is signed against with the private key corresponding to the already-exchanged public key. Each counterparty has logged into their client device 101 using their account email. The account email is tied to a public key. The user signs (approves) the local version of the digital contract. The signing process, in a preferred embodiment, uses Elliptic Curve Digital Signature Algorithm (ECDSA). ECDSA takes an arbitrary piece of data (in this case, the serialized contract) as the “message” and a private key that is associated with the already-exchanged public key and produces a digital signature that represents agreement. In other embodiments, similar signature algorithms can be used, such as Schnorr. The signature can then be shared with their counterparty to prove agreement of the contract terms. By using ECDSA to verify the signature of the digital contract against the known public key of their counterparty using the serialized contract as the message for the signature verification, such as shown in FIG. 6, each party ensures that they have an identical copy of the contract, and thus identical understanding of the contract terms. Each digital contract points to specific counterparties. With the counterparty public key and matching signature, parties can validate the signatures match the digital contract using whatever agreed-upon digital signature algorithm that was used to generate the signature, such as ECDSA. The signatures are shared, in some embodiments, peer-to-peer, with the assistance of the coordination server. Verified signatures by both parties trigger start of contract settlement.

### Contract Agreement, Signing, and Verification

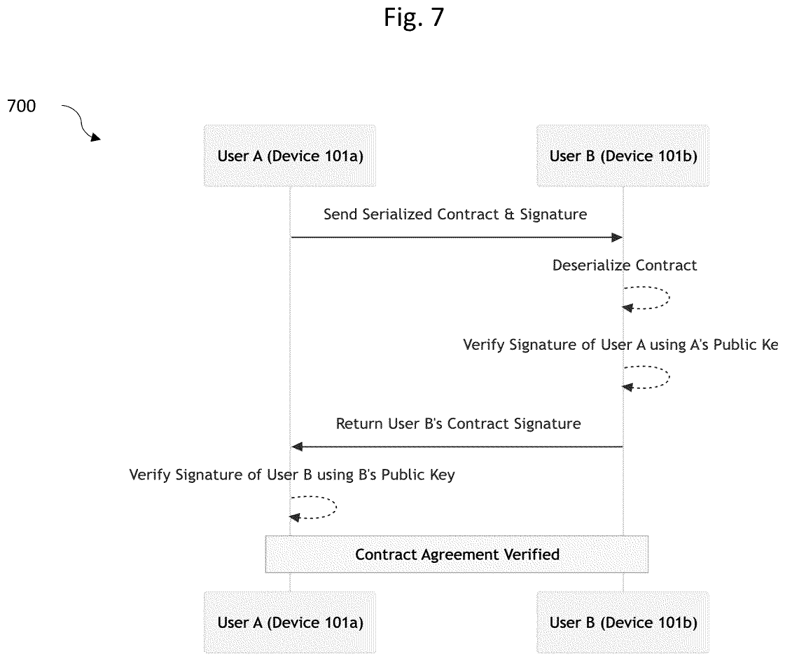

Turning to FIG. 7, contracts are serialized, exchanged, and cryptographically signed, ensuring that both parties have an identical understanding of the agreed-upon terms. By verifying the signature of the contract against the known public key of their counterparty, each party can be confident that their counterparty has the same contract. As shown in FIG. 7, assume a user A (using client device 101a) would like to initiate a contract with user B (using client device 101b). First, the client device of user A (client device 101a) serializes the agreed contract terms into a digital contract file. A digital signature is created by signing the contract file with the private key of user A. The digital signature, along with user A's public key, is transmitted to user B (at client device 101b), where the signature can be validated to ensure the signed contract matches the terms of what is stored on user B's device. Each party uses the other's public key to verify the contract's digital signature, ensuring both sides are working on an identical copy of the terms of the contract. Once verification succeeds, user B countersigns the contract with their private key and returns the signed signature to user A. Once exchanged, both client devices 101 stores a copy of the identical contract in their local memory, each signed by the counterparty, thereby formally establishing a mutually verifiable agreement.

### Changes to the Digital Contract

Counterparties may need to implement a change to the contract terms. Depending on the scope of the change and/or counterparty agreement, changes may be made directly to the deserialized contract on each client device individually and thus do not require signatures. In other embodiments, changes may follow the same serialization, deserialization and signing process as the original digital contract agreement. In either embodiment the counterparties' confirmation of invoice amounts and/or approval of payment request amounts utilizing the collaborative consensus protocol guarantee the client devices are operating from the exact same digital contract.

### Invoice Exchange and Cross-Verification

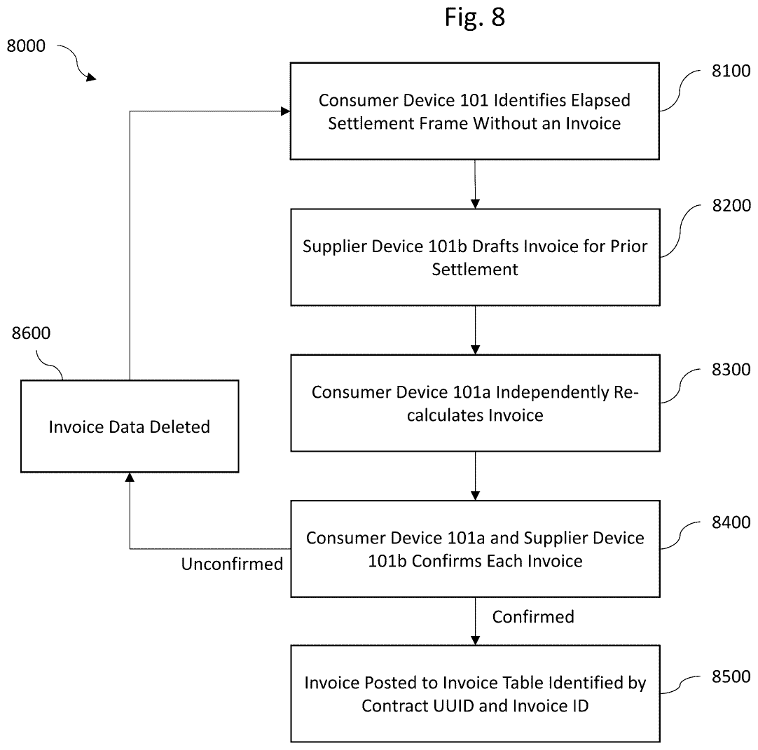

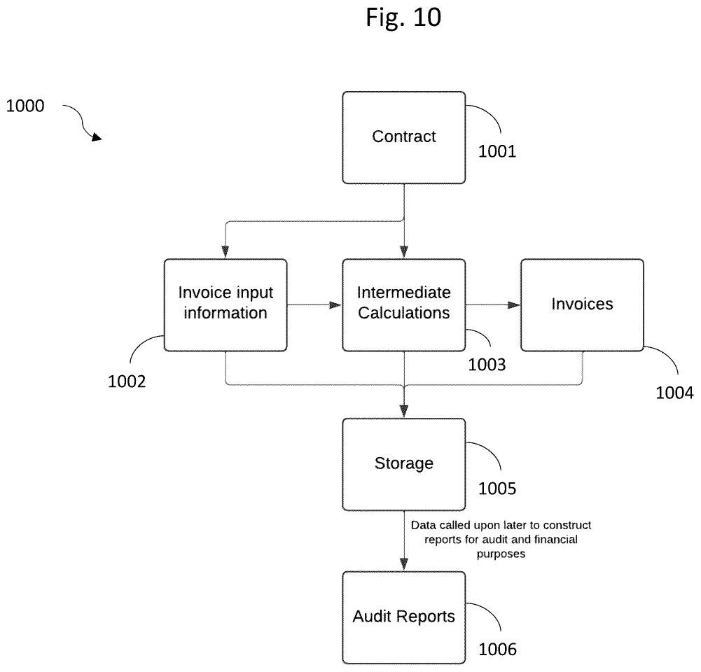

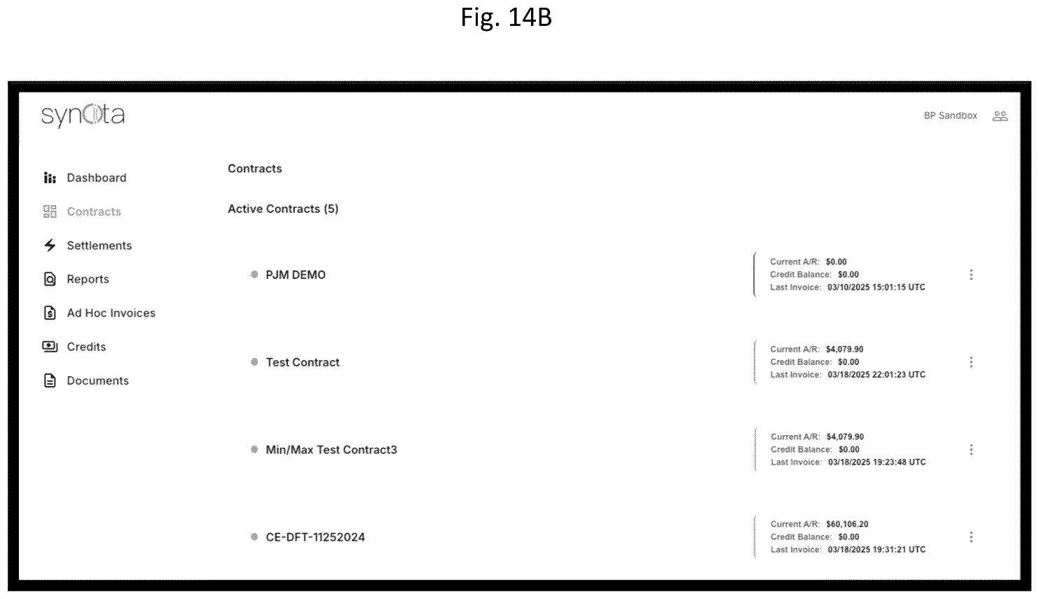

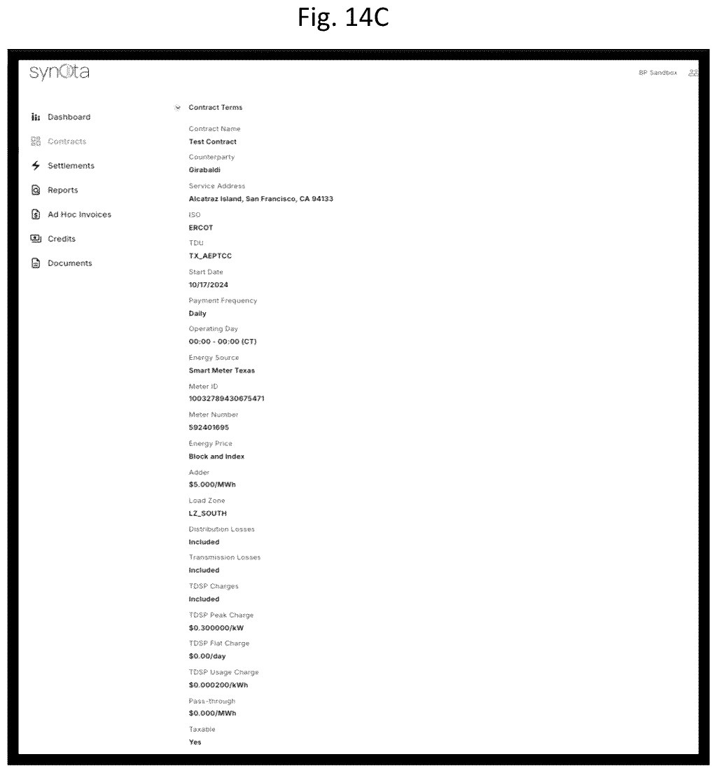

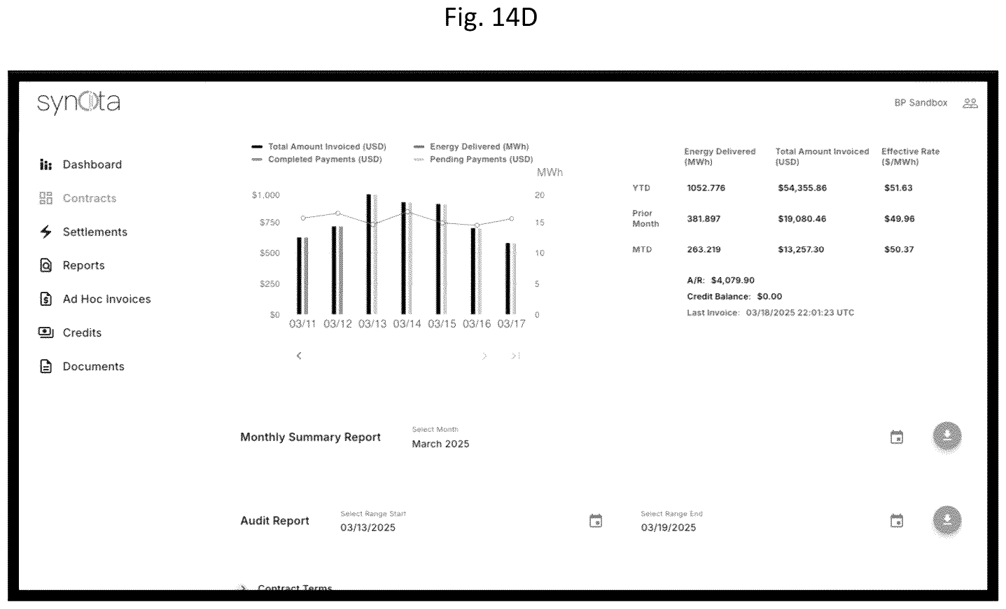

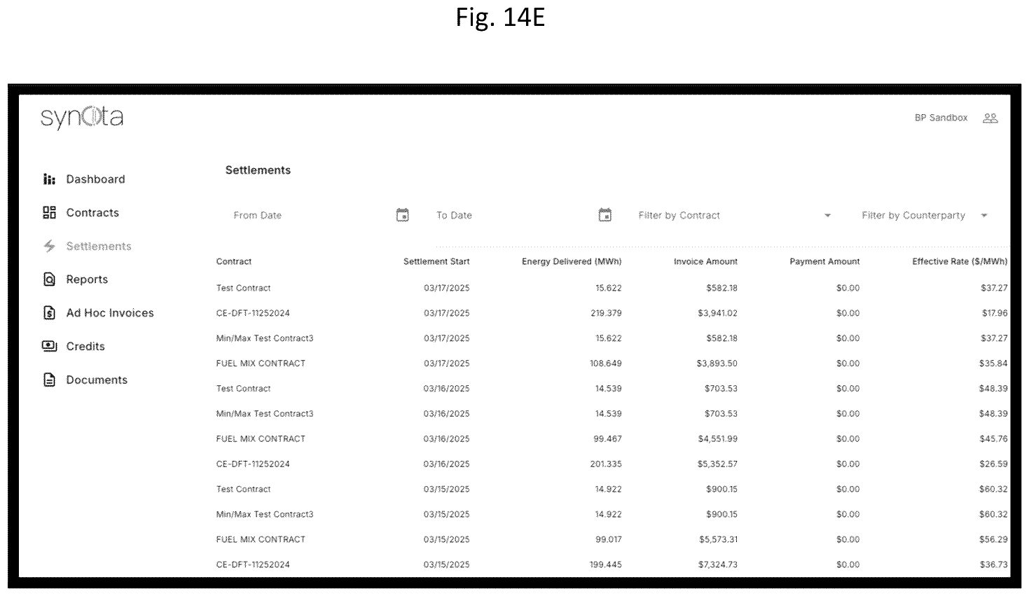

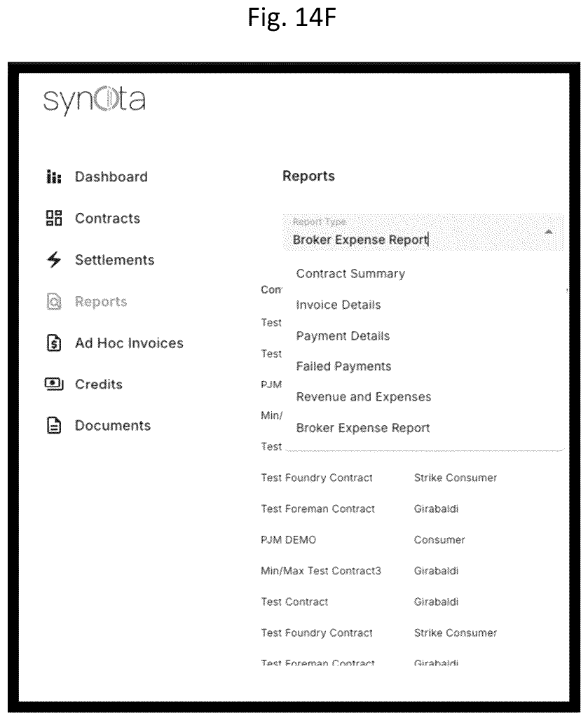

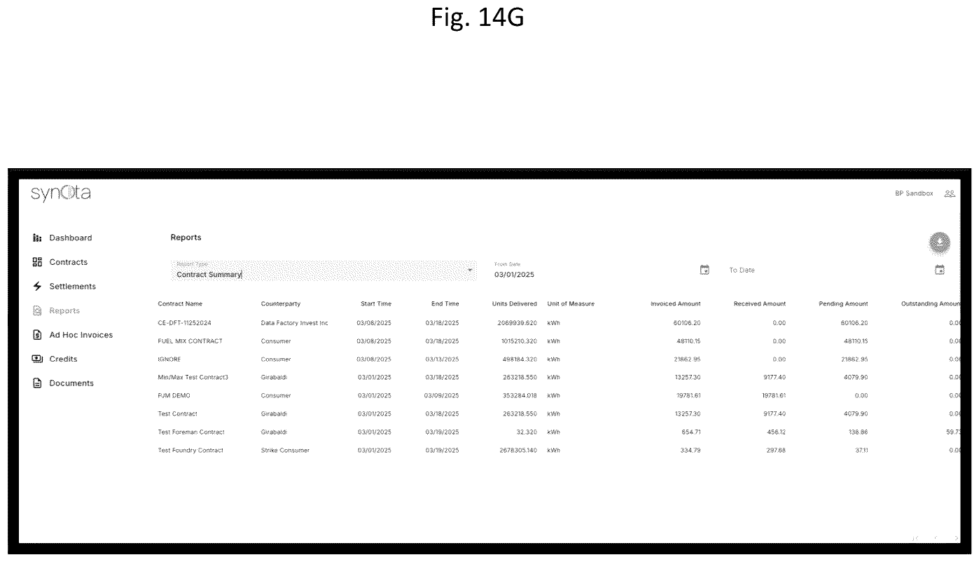

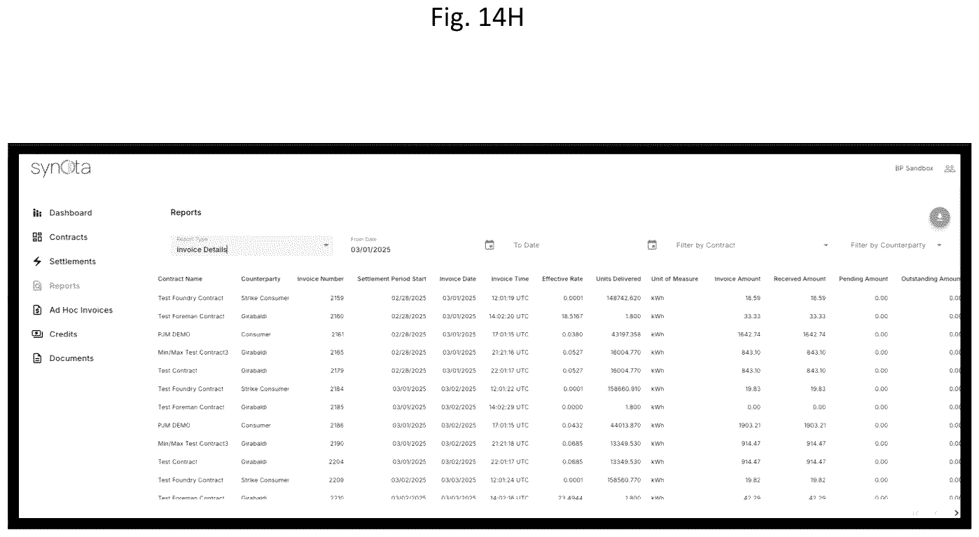

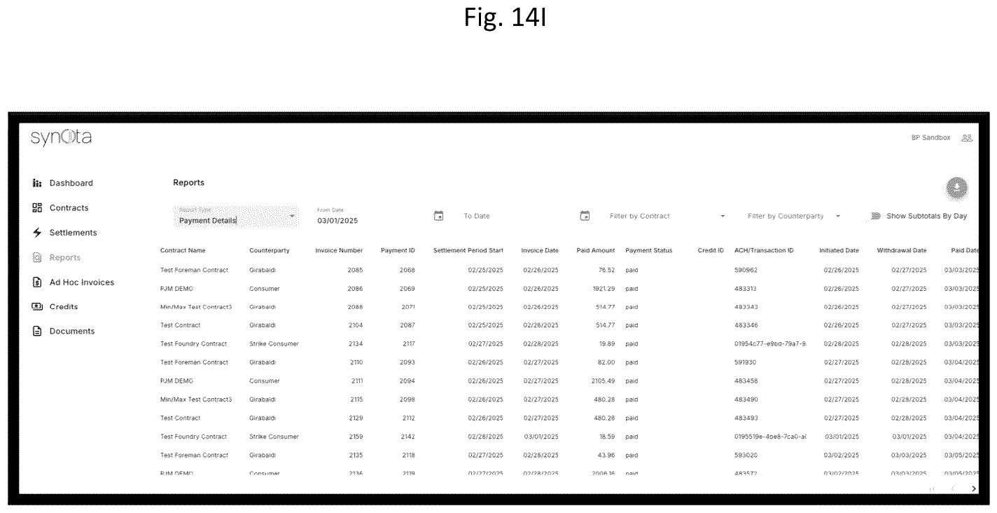

Turning to FIG. 8, the collaborative consensus protocol streamlines the exchange and verification of invoices between counterparties by automating the process of proposing, verifying, and accepting draft invoices, such as via process 8000. In some embodiments, each invoice is identified by a combination of the digital contract UUID and invoice ID. The process starts at process 8100 by the consumer device 101a identifying any elapsed settlement frames without a completed invoice. At process 8200, a supplier (via supplier server 101b) generates a draft invoice based on the agreed-upon contract. It does this by querying/polling previously agreed upon data sources for the input information. For example, in the energy and payments example, this can include, but is not limited to, acquiring interval meter data from advanced metering infrastructure (AMI) via secure internet protocols (e.g., HTTPS), retrieving locational marginal pricing (LMP) and tariff rate schedules from an independent system operator's (ISO) market data portal, and integrating real-time grid telemetry for settlement calculations. Each client device may integrate additional external data sources, such as weather forecasts, to provide real-time inputs to AI agents for decision-making. The calculation(s) for the invoice's outputs are performed by the client server (e.g., via contract execution software that takes the contract's agreed-upon parameters and the input information and evaluates to a set of output(s)). Such calculations may be performed by AI agents using predictive models or machine learning techniques to optimize the outputs. The outputs are then placed into a data structure referred to as an invoice, such as shown in FIG. 8. This invoice contains the output information from calculations performed for a given contract over a given settlement frame with externally gathered inputs. This output information, along with storage of input information can be later used for financial, operation, and audit purposes, such as shown in FIGS. 10 and 14A-I. In some embodiments, the output information includes amounts owed, settlement frame beginning and ending times, and storage of the input information for this invoice. In other embodiments, where contract execution does not involve financial settlement, output information includes operational metrics, audit logs, reports of data discrepancies, completion timestamps. Each dataset follows a contract-defined schema and is subject to the same cross-verification process as invoices.

At step 8300, this invoice is then sent to the consumer (via consumer device 101a), who generates their own local invoice using the specifications on the digital contract stored locally, described above. If the invoice values between the supplier and consumer devices match (decision block 8400), the consumer device 101a confirms the invoice (process 8500). In some embodiments, counterparties agree to a tolerance window, wherein the invoice amounts calculated by each device independently do not need to match exactly, but the outputs must fall within a specified and acceptable tolerance window. A tolerance window can be set on a per contract basis in the digital contract terms. Additionally and/or alternatively, the tolerance window can be defined relative to a maximum percentage difference, a maximum nominal amount difference, a combination of both, or defined by an AI agent.

If the invoice values do not match or fall outside the tolerance window (decision block 8400), the consumer rejects the invoice (process 8600), prompting the supplier to generate a new invoice. This is done based on the assumption—given the verified signature—that the two servers are both evaluating the input information in the same manner. Thus, if the output information for a given settlement frame is different between the servers, then the input information is different, and must be re-gathered by both parties. The requirement to regather the data assumes that the data was bad for either (or both) party because of data availability issues, data being altered, or other unknown issues. For example, the supplier communicates a failure to the consumer server, which determines whether the supplier number was low or high. Failures are stored in the general application log. Because the supplier failed, no invoice is saved for the time period, so when the standard flow runs again, it will see a missing invoice for the time period and attempt to recalculate. The process will not attempt future invoices until all periods have a verified invoice. Each contract has established settlement frames, invoices for each frame are stored in an invoice table (local on both client servers), and if there is a lapsed settlement frame without an invoice, the supplier starts with the oldest lapsed settlement frame. This iterative process continues until both parties agree on the settlement outputs, creating a verified invoice (automated redundancy). At step 8500, once both invoices are confirmed, payment is transmitted from the consumer device 101a to the supplier device 101b for processing. In some embodiments, the digital contract may specify circumstances to seek alternative data sources. The digital contract terms determine the circumstances, timing and alternative data sources polled.

### Payment Exchange and Cross-Verification

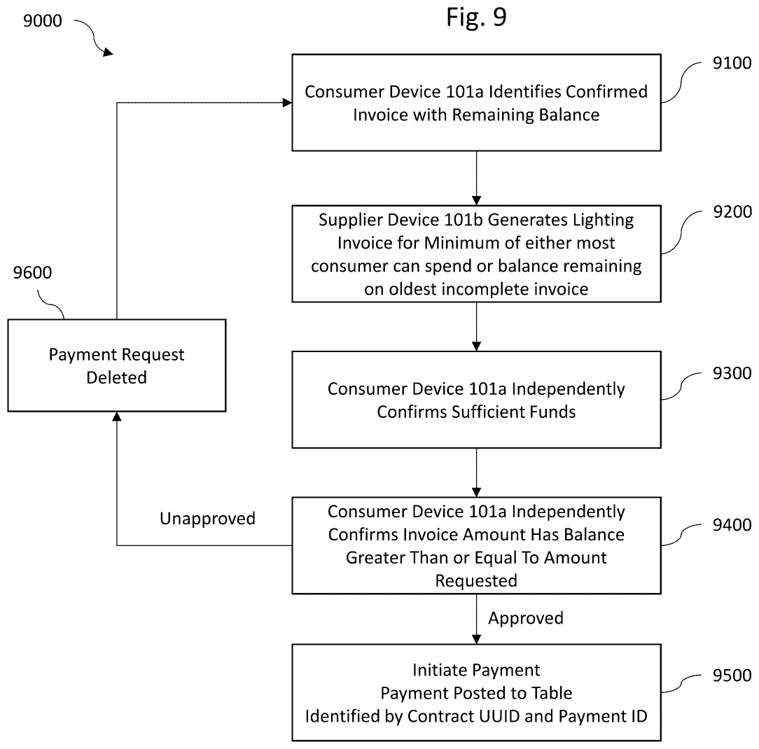

Turning to FIG. 9, similarly, the collaborative consensus protocol automates the exchange and verification of payment amounts between counterparties by proposing, verifying, and accepting draft payment requests, such as shown as process 9000. Each successful payment can be identified by a combination of the Digital Contract UUID and Payment ID. In embodiments that do not permit partial payments, the consumer device can request a Draft Payment Request if the Invoice Table has an Invoice with no associated payment IDs in a pending or paid state. The process 9000 begins at step 9100 where the consumer device 101a identifies confirmed invoices with a remaining balance. At step 9200, the supplier (via the supplier device 101b) generates a draft payment request based on the agreed-upon invoice, which is then sent to the consumer (via the consumer device 101a). The draft payment request may be generated or adjusted by an AI agent that considers real-time conditions, such as market fluctuations or usage patterns, to optimize the payment amount within the contract's constraints. This draft payment includes the amount owed and the payment method required to send the funds to the supplier. At step 9300, the consumer (via the consumer device 101a) verifies that the payment amount is less than the remaining unpaid balance in the invoice and within an appropriate tolerance window. Some embodiments allow for partial payment, while others require full payment. In some embodiments where currency exchange rate is a factor, a tolerance window could be acceptable and defined in terms of the exchange rate. If the payment values meet the criteria (decision block 9400), the consumer accepts the payment draft request and makes the payment (step 9500). The process of making a payment varies based on the payment method. When using the Lightning Network for Bitcoin payments, payment is effectuated by the consumer device requesting a Lightning Network invoice. Using external APIs, the Supplier (or its agent) sends an invoice for payment in Bitcoin. When utilizing ACH, the payment request is put in a pending status and payment instructions communicated to consumer, or consumer's agent via external API. This automated process reduces the risk of errors and streamlines the payment exchange between counterparties. Otherwise, the payment request is denied and deleted at step 9600.

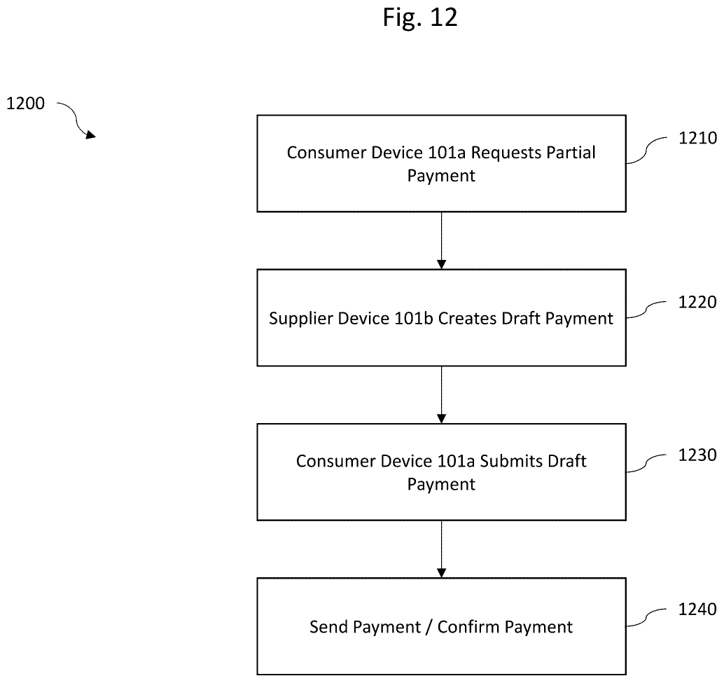

In embodiments supporting partial payments, such as shown in FIG. 12, the consumer device can sum all payments IDs in a pending or paid state and request a Draft Payment Request for the lesser of the invoice remaining balance or consumer's available funds.

### Payments

The collaborative consensus protocol operates as a modular framework, ensuring that the validation and agreement processes are decoupled from the execution of financial transactions. This means that even in cases where a payment fails, is delayed, or is not required, the collaborative consensus process remains intact, having already established a verified and mutually agreed-upon contract state between counterparties.

By integrating payment execution within this framework, the protocol enables automated, trustless settlement across any payment rail that supports programmable execution. This modular architecture ensures that contract validation, dispute resolution, and financial settlement remain independent processes, allowing for seamless integration with existing financial infrastructure while preserving the integrity and auditability of contractual execution.

Payments can be stored on a separate table; each row has a required foreign key that points to a specific invoice. From that table, whether there are multiple payments tied to a single invoice is easily determined. There should only be one pending or successful payment per invoice. If there are no successful payments, or all have failed, then we create a new one. This step occurs prior to creating the draft payment request. In some embodiments where partial payments are permitted, a payment will be created when pending or successful payments summed up are less than the invoice amount. Payments may also use digital assets, including cryptocurrencies and stablecoins, stored in digital wallets, supporting secure and programmable transactions across diverse networked environments.

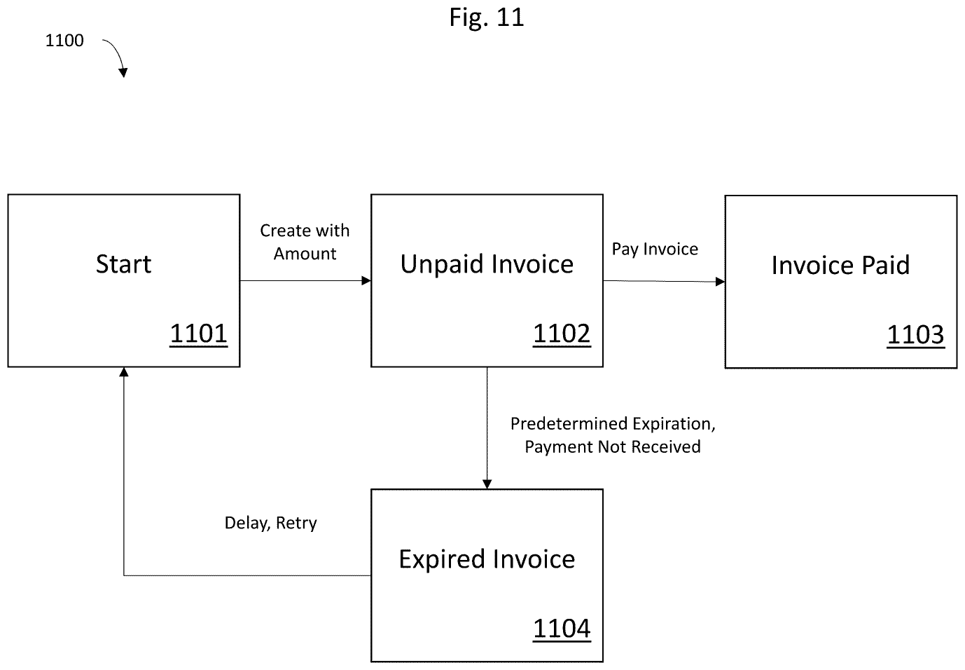

With reference to FIG. 11, the collaborative consensus protocol supports atomic payments, ensuring that each payment transaction is executed as an indivisible step-either completing successfully or failing entirely. While payments must be discreet transactions, the system allows for partial payments, enabling counterparties to incrementally settle outstanding balances. Unlike traditional payment methods, atomic payments do not have a “pending” state, meaning a transaction is always “unpaid”, “paid”, or “expired” (such as shown in FIG. 11). An unpaid invoice can only have two actions to change its state, being fully paid in its exact amount (through one or multiple payments), or with the elapsing of time, changing its state to expired.

In some embodiments, Lightning Network payments offer atomicity and instant settlement. Lightning Network payments typically include invoices with an expiration time (defined field in the invoice).

Turning to FIG. 12, partial payments are available in some embodiments. Partial payments allow consumers to make a payment toward an outstanding balance on one or more invoices that is less than the outstanding balance. In this embodiment, the consumer device defines a limit for spending when asking for a draft payment request, and will reject a draft payment request coming from their supplier device if it is greater than the defined limit.

In some embodiments, using a “pending” state enables other payment methods, such as the Automated Clearing House (ACH) and FedWire. Traditional payment methods have a pending state where payments have been initiated from consumer to supplier but have yet to complete or fail. This leads to a further complication that must be handled in the logic of the system to not retry pending payments, even though they have been initiated, but are yet to succeed. This embodiment includes a new conditional branch to determine if a payment is pending when considering creating a new payment for an existing invoice.

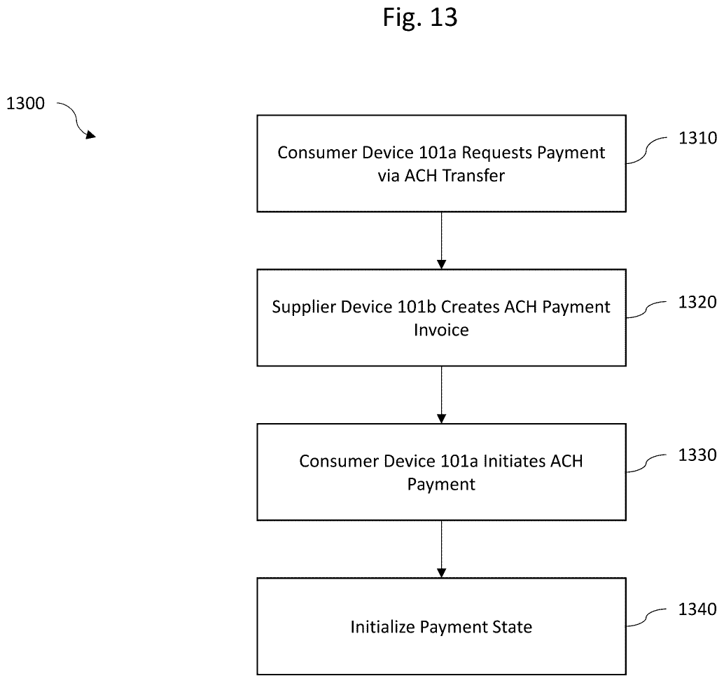

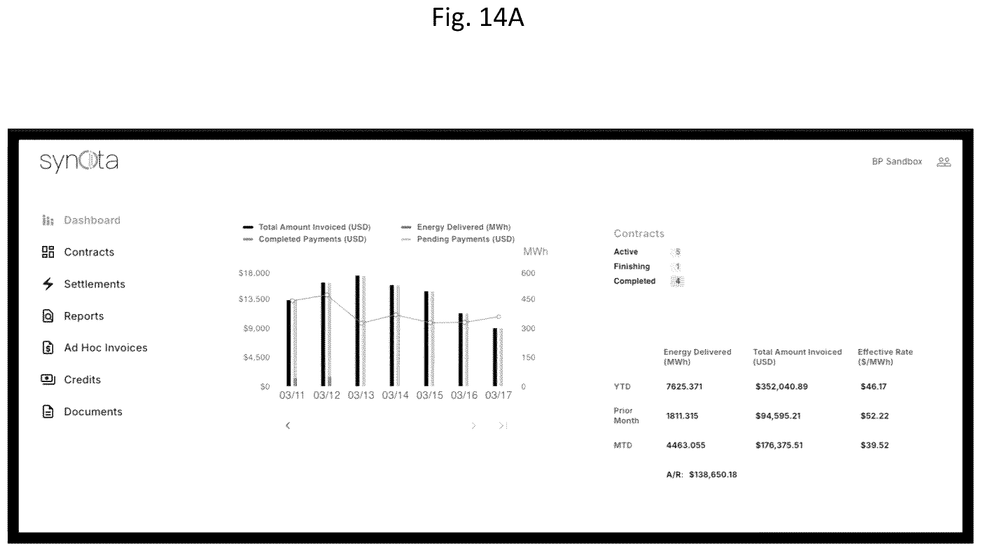

Turning to FIG. 13, an exemplary process for handling payments through an external banking network (e.g., ACH transfers) is shown. In this embodiment, after the consumer requests a payment via a bank transfer (via consumer device 101a), the supplier device 101b generates a draft payment instruction (such as an ACH payment request) instead of a Lightning invoice. The consumer device 101a (or its linked bank agent) initiates the payment through the banking network. Because such payments have a pending state (not instant), the system includes a conditional check: if a payment is already pending for a given invoice, no new payment request is generated until the first transaction clears. Once the bank transfer is confirmed (funds received) or a timeout occurs, the invoice status is updated accordingly. FIG. 13 shows the additional steps and conditional branches for integrating non-instant, bank-mediated payments into the collaborative consensus protocol.

Turning to FIG. 10, one embodiment of a data flow for preparing audit reports of the collaborative consensus protocol of FIG. 1 is shown. The input information, calculations, invoice and payment amounts can be stored on the client device. Only data for verified invoices and payments is stored on the client device. Using internal APIs, all data stored on client device is accessible to user in detailed and summary reports. Because of collaborative consensus, calculations and invoice amounts on user reports will match the counterparty's reports for the same UUID. Because the counterparties had the same terms at signing and agreed on the invoice and draft payment request, we can infer they have the same contract.

FIGS. 14A-I each show an exemplary user interface illustrating various features of the collaborative consensus protocol of FIG. 1. FIG. 14A shows an exemplary user interface for an overview dashboard, presenting a consolidated summary of any active digital contracts, current status, total amount owed, and other system data. FIG. 14B illustrates one exemplary user interface for a contract overview, which shows a list of active digital contracts, including contract ID, current status, total amount owed, recent transactions, and usage metrics. FIG. 14C shows an embodiment of an interface for viewing the terms of a contract, which is derived from the deserialized contract terms. FIG. 14D shows an embodiment of an interface for viewing a selected contract, which is similar to the overview dashboard of FIG. 14A, for a particular contract. FIGS. 14E-I each shows an exemplary user interface for various reporting tools (e.g., invoice and payments history, contract settlements, and additional data supporting the digital contract and associated transactions.

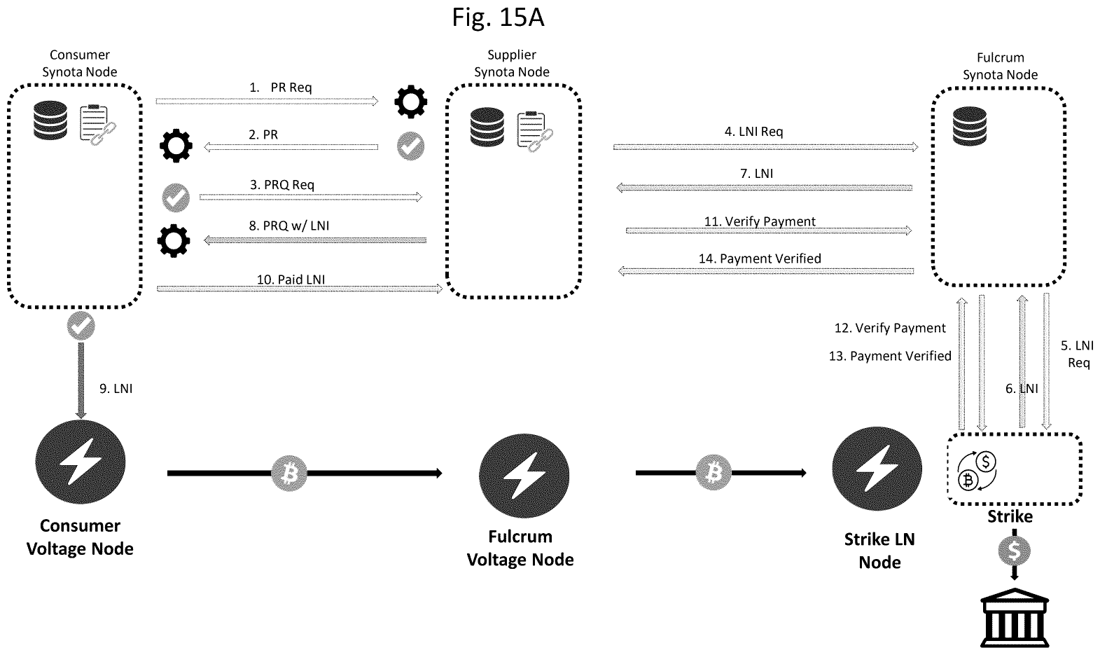

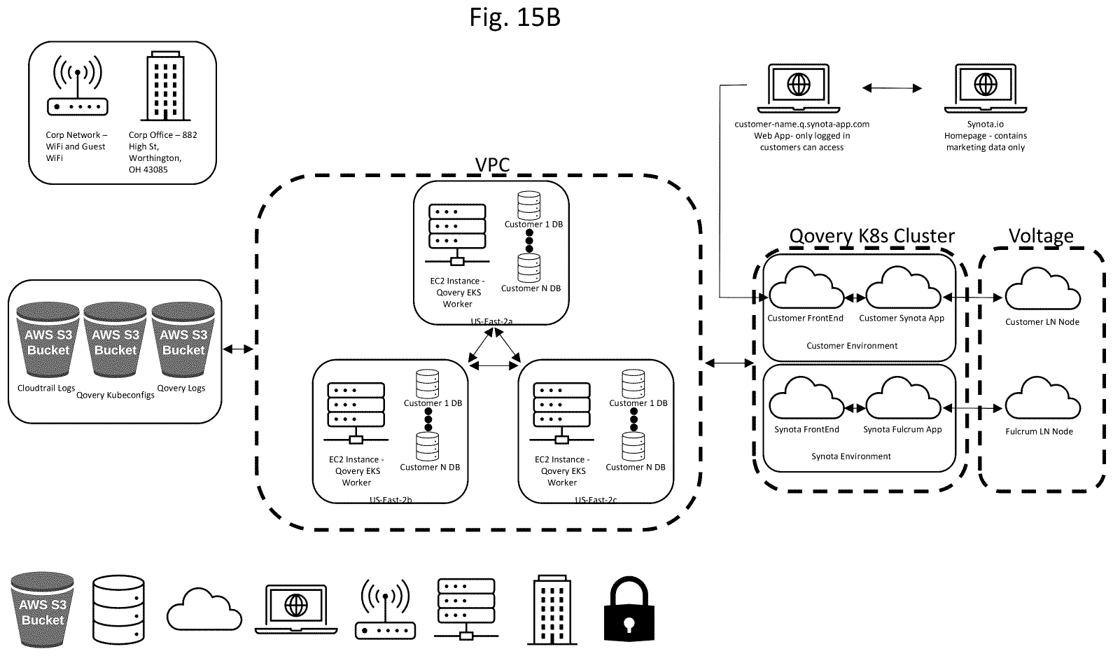

FIGS. 15A-B each show an exemplary embodiment of the system environment of the collaborative consensus protocol of FIG. 1. FIG. 15A shows an exemplary dataflow across the system environment for payments made through the Lightning Network. In this embodiment, the client devices rely on a third-party server to communicate the exchange rate and payment instructions directly with the exchange server provider (e.g., a bitcoin exchange service provider). FIG. 15B shows an exemplary dataflow in a system environment for payments made through the ACH network.

### Invoices and Payments as Independent Modules

In some embodiments, the invoicing and payments modules have large degrees of flexibility and only one point of interaction: making payments when able and there is an outstanding balance on an invoice. By having large flexibility and low interaction between these two modules, invoicing and payments can be changed or updated independently. In some embodiments, it is possible to make changes to how invoices are calculated with no effect on how payments are performed. Likewise, in some embodiments, payments can be made via several different payment methods, all independently of how the invoice itself was calculated.

### Game-Theoretic Analysis

A game-theoretic analysis of the protocol's incentives and disincentives for cooperation demonstrates that it is in both parties' long-term interests to cooperate and adhere to the protocol. By providing quicker feedback and enabling near-real-time settlements, the protocol reduces the potential impact of cheating behavior by counterparties. The analysis highlights the reduced moral hazard and clear present value downside for cheating, making cooperation the rational choice for both parties. AI agents embedded in client devices can be programmed to follow cooperative strategies, enhancing adherence to the protocol and maximizing long-term payoffs. Self-enforcing mechanisms, supported by automated verification, promote cooperation by ensuring prompt enforcement of terms across any digital system.

A further analysis using an augmented caterpillar game to demonstrate the Nash Equilibrium of not cheating for both players:

To analyze the incentives for cooperation and non-cheating behavior, we can model the interaction between the two counterparties as an infinitely repeated game, known as the “Augmented Caterpillar Game.”

In this game, each player (counterparty) has two possible actions in each round (settlement period):
(1) Cooperate (C): Follow the protocol honestly and make payments that are owed or supply power that is expected.
(2) Defect (D): Cheat by not paying for services rendered or not supplying units as agreed upon.

The payoffs for each player in a single round are represented by the following matrix:
Player 2
Cooperate (C) Defect (D)
Player 1 Cooperate (C) (R, R) (S, T)
Defect (D) (T, S) (P, P)

Where:
R is the reward payoff for mutual cooperation
T is the temptation payoff for defecting while the other player cooperates
S is the sucker's payoff for cooperating while the other player defects
P is the punishment payoff for mutual defection

Assuming that the players are rational and aiming to maximize their long-term payoffs, the following inequalities must hold for the game to be considered a Prisoner's Dilemma:

T>R>P>S

Additionally, to ensure that cooperation is preferable to alternating between cooperation and defection, we need:

2R>T+S

In the context of the collaborative consensus protocol, we can assign reasonable payoff values based on the potential gains and losses from cheating or cooperating:
R=3 (Mutual cooperation: Both parties benefit from efficient, transparent settlements)
T=5 (Temptation payoff: Short-term gain from cheating, but long-term loss of trust)
S=0 (Sucker's payoff: Loss from being cheated on)
P=1 (Punishment payoff: Mutual cheating leads to inefficient, distrustful settlements)

These payoff values satisfy the Prisoner's Dilemma inequalities: 5>3>1>0, and 2 (3)>5+0.

However, in the infinitely repeated Augmented Caterpillar Game, the players must consider not only the current round's payoff but also the long-term consequences of their actions. If a player defects, the other player can punish them in subsequent rounds by also defecting, leading to a long-term payoff of P in each round.

Let's define the following:
δ is the discount factor, representing the players' patience or the importance they place on future payoffs (0<δ<1)
V (C, C) is the long-term payoff for mutual cooperation
V (D, C) is the long-term payoff for defecting while the other player cooperates

If both players cooperate indefinitely, the long-term payoff for each player is:

$$V ( C , C ) = R + δ R + δ \hat{} 2 R + … = R / ( 1 - δ )$$

If a player defects while the other cooperates, they gain the temptation payoff T in the current round, but the other player will defect in all subsequent rounds, leading to a long-term payoff of:

$$V ( D , C ) = T + δ P + δ \hat{} 2 P + … = T + δ P / ( 1 - δ )$$

For cooperation to be a Nash Equilibrium (i.e., the optimal strategy for both players), the long-term payoff from cooperating must be greater than or equal to the long-term payoff from defecting:

$$V ( C , C ) \geq V ( D , C ) R / ( 1 - δ ) \geq T + δ P / ( 1 - δ )$$

Substituting the payoff values:

$$3 / ( 1 - δ ) \geq 5 + δ / ( 1 - δ )$$

Solving for 8, we find that cooperation is a Nash Equilibrium when:

$$δ \geq 1 / 2 \approx 0.5$$

By designing the protocol to enable frequent, near-real-time settlement cycles, the potential impact of any attempted cheating behavior is minimized, and counterparties receive quicker feedback, further incentivizing cooperation. Additionally, the clear present-value downside of being caught cheating and losing trust in the long run outweighs any short-term gains from defecting.

Therefore, in the Augmented Caterpillar Game representing the collaborative consensus protocol, the Nash Equilibrium strategy for both players is to cooperate and not cheat, as long as they value future payoffs sufficiently (δ>0.286). This game-theoretic analysis supports the collaborative consensus protocol's ability to mitigate moral hazard concerns and incentivize cooperation between counterparties.

The key features of the protocol include:

Verifiable Contract Agreement: Contracts are serialized, exchanged, and cryptographically signed, ensuring that both parties have an identical understanding of the agreed-upon terms.

Collaborative Output Verification: Draft invoices are iteratively proposed and verified by both parties until the values fall within an acceptable tolerance window, establishing consensus on the settlement outputs.

Automated Payment and Payment Verification: Similarly, draft payments are proposed and verified against the agreed-upon invoice, streamlining the payment process, and reducing the risk of errors.

By enabling frequent, near-real-time settlement cycles, the protocol minimizes the potential impact of any attempted cheating behavior, as counterparties receive quicker feedback and can take corrective action promptly. The game-theoretic analysis presented demonstrates that cooperating and adhering to the protocol is in both parties' long-term interests, mitigating moral hazard concerns.

While the protocol relies on a certain level of trust between counterparties (which can be known ahead of time, and set explicitly by the parties involved in the contract by specifying shorter (less trust needed) or longer (more trust needed) settlement periods), it significantly reduces the overhead and risks associated with traditional manual reconciliation processes by introducing independent checking of the settlement data and payments to reduce anomalies and bad behavior amongst the counterparties. In doing so, governance and risk controls can be set by the consumer and/or supplier. This allows each to set acceptable exposure levels to amounts allowed to be autonomously pulled for payments and exposure of credit.

The collaborative consensus protocol has broad applicability in various domains where counterparties need to establish automated, verifiable agreement on contractual terms, inputs, and outputs. In the energy sector, it can streamline the settlement of contracts involving energy data, usage amounts, and cost calculations, enabling more efficient and transparent energy trading and billing processes.

As peer-to-peer technologies and secure communication channels continue to evolve, protocols like the one proposed in this disclosure will play a crucial role in facilitating trustworthy, automated interactions between parties without the need for costly global consensus mechanisms or intermediaries. By leveraging the strengths of cryptography and collaborative verification, we can unlock new levels of efficiency, transparency, and trust in contractual relationships, while avoiding the scalability and cost challenges associated with public blockchain networks.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel”, “perpendicular”, “round”, or “square”, are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72 (b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A collaborative consensus protocol system for automated, verifiable agreement between counterparties, comprising:
a first consumer device;
a data network;
a second supplier device in operable communication with the first consumer device over the data network, wherein the first consumer device provides contracts to the second supplier device in a serialized format, the second supplier device deserializes the contract into machine-readable representations, the provided contract being signed against a private key corresponding to a public-key exchanged between the first consumer device and second supplier device and automates the exchange and verification of payments related to the contract.

2. The collaborative consensus protocol system of claim 1, wherein the first consumer device and the second supplier device are in direct peer-to-peer communication without a central server.

3. The collaborative consensus protocol system of claim 2, wherein the first consumer device and the second supplier device exchange at least a node identifier and a public key to establish the direct peer-to-peer communication.

4. The collaborative consensus protocol system of claim 1, wherein each device generates an independent invoice based on the serialized format of the contract and compares settlement outputs for each independent invoice for collaborative output verification.

5. The collaborative consensus protocol system of claim 4, wherein said comparison of settlement outputs for each independent invoice comprises comparing at least one of an invoice amount, calculation subtotals, payment amount, and informational reports of the contract.

6. The collaborative consensus protocol system of claim 4, wherein said first consumer device and said second supplier device automates the exchange and verification of payments related to the contract upon a determination that the compared settlement outputs differ within a predetermined tolerance window.

7. The collaborative consensus protocol system of claim 6, wherein said first consumer device gathers inputs of the serialized contracts a second time for automatic verification by the second supplier device upon the determination that the compared settlement outputs differ outside the predetermined tolerance window.

8. The collaborative consensus protocol system of claim 1, wherein said first consumer device provides contracts to the second supplier device in a serialized format using JavaScript Object Notation.

9. The collaborative consensus protocol system of claim 1, wherein said provided contract being signed against a private key corresponding to a public-key exchanged between the first consumer device and second supplier device comprises the first consumer device signing using at least one of Elliptic Curve Digital Signature Algorithm and Schnorr.

10. The collaborative consensus protocol system of claim 1, wherein each of the first consumer device and the second supplier device maintains a digital contract table, an invoice table, and a payment table stored on local hardware for each device, wherein the provided contracts are each identified by a universally unique identifier maintained in each digital contract table, the universally unique identifier for each contract being identical across the first consumer device and the second consumer device.

11. A method for automating contract settlement and enforcement through a collaborative consensus protocol between counterparties, comprising:
serializing a digital contract at a first consumer device;
providing, to a second supplier device in operable communication with the first consumer device over a data network, the serialized contracts; and
deserializing, at the second supplier device, the provided serialized contract into machine-readable representations, the provided contract being signed against a private key corresponding to a public-key exchanged between the first consumer device and second supplier device and automates the exchange and verification of payments related to the contract.

12. The method for automating contract settlement and enforcement of claim 11, further comprising establishing a direct peer-to-peer communication between the first consumer device and the second supplier device without a central server.

13. The method for automating contract settlement and enforcement of claim 12, further comprising exchanging at least a node identifier and a public key between the first consumer device and the second supplier device to establish the direct peer-to-peer communication.

14. The method for automating contract settlement and enforcement of claim 11, further comprising each device generating an independent draft invoice based on the serialized format of the contract and comparing settlement outputs for each independent draft invoice for collaborative output verification.

15. The method for automating contract settlement and enforcement of claim 14, wherein said comparing settlement outputs for each independent draft invoice comprises comparing at least one of an invoice amount, calculation subtotals, payment amount, and informational reports of the contract.

16. The method for automating contract settlement and enforcement of claim 14, further comprising automating the exchange and verification of payments related to the contract via said first consumer device and said second supplier device upon a determination that the compared settlement outputs differ within a predetermined tolerance window.

17. The method for automating contract settlement and enforcement of claim 16, further comprising providing, via said first consumer device, the digital contracts to the second supplier device in a serialized format a second time for automatic verification by the second supplier device upon the determination that the compared settlement outputs differ outside the predetermined tolerance window.

18. The method for automating contract settlement and enforcement of claim 11, wherein said serializing a digital contract at a first consumer device comprises serializing the digital contract using JavaScript Object Notation.

19. The method for automating contract settlement and enforcement of claim 11, wherein said provided contract being signed against a private key corresponding to a public-key exchanged between the first consumer device and second supplier device comprises the first consumer device signing using at least one of Elliptic Curve Digital Signature Algorithm and Schnorr.

20. The method for automating contract settlement and enforcement of claim 11, wherein each of the first consumer device and the second supplier device maintains a digital contract table, an invoice table, and a payment table stored on local hardware for each device, wherein the provided contracts are each identified by a universally unique identifier maintained in each digital contract table, the universally unique identifier for each contract being identical across the first consumer device and the second consumer device.
